(19) United States
(12) Patent Application Publication
(10) Pub. No.: US 2017/0366103 A1
(43) Pub. Date: Dec. 21, 2017

(54) ONE-DIRECTIONAL PISTON-TUBE ELECTROSTATIC MICROACTUATOR

(71) Applicants: Faez BA-TIS, Toronto (CA); Ridha BEN-MRAD, Toronto (CA)

(72) Inventors: Faez BA-TIS, Toronto (CA); Ridha BEN-MRAD, Toronto (CA)

(21) Appl. No.: 15/187,012

(22) Filed: Jun. 20, 2016

(51) Int. Cl. H02N 1/00

(52) U.S. Cl. CPC H02N 1/002

(57) ABSTRACT

A MEMS electrostatic piston-tube actuator is disclosed. The actuator comprises two structures. A structure that comprises a plurality of fixed piston-like electrodes that are attached to a base, and form the stator of the actuator. A second structure that comprises a plurality of moving tube-like electrodes that are attached to the body of the upper structure and form the rotor of the actuator. The rotor is attached to the stator through a mechanical spring. The rotor of the actuator provides a translational motion, about the normal axis to the structures. The present piston-tube actuator utilizes a configuration that enables the use of wide area electrodes, and therefore, provides a high output force enabling translation of the rotor.

### FIELD OF THE INVENTION

The invention relates to the field of microactuators that provide high force, and/or large out-of-plane translation stroke.

### BACKGROUND OF THE INVENTION

Large out-of-plane translation and high output force microactuators have a wide range of applications in adaptive optics and in micro robotics. In adaptive optics, they are used for auto-focus and Optical Image Stabilization (OIS) in miniature cameras and deformable micromirrors. For the auto-focus in phone cameras application, the actuator is required to translate a lens of 3 mg in mass or translate the lens barrel typically of 45 mg in mass along the optical axis for 80-100 μm. In micro robotics, large stroke and high output force actuators are used in micro assembly systems and microgrippers.

Different micro actuation methods are in use. These include electromagnetic, piezoelectric, and electrostatic microactuators. The electromagnetic actuators provide large stroke and high output force; nevertheless, they are known to have a number of disadvantages such as high power consumption and large size. Although piezoelectric actuators provide high output force, they are sensitive to temperature and are difficult to fabricate. Electrostatic actuators offer high speed response, low power consumption, and small size. However, it is challenging to design electrostatic actuators that can simultaneously provide high output force, large out-of-plane stroke and while maintaining a low voltage.

The electrostatic actuators that provide an out-of-plane stroke include parallel plate and Vertical Comb-Drive (VCD) actuators. The former suffers from the pull-in effect which limits the vertical stroke of the actuator to one third of the initial gap between the plates. The latter could be divided into two types: rotational and translational (piston-style) VCD actuators.

In rotational comb-drive actuators (including staggered and angular VCD actuators), the original motion of the rotor is a rotation, thus providing a rotational out-of-plane stroke; however, these actuators often utilize mechanical amplification mechanisms, such as levers, to enlarge the stroke as well as to transform the original rotary motion of the rotor into a translation of the load. Due to the motion amplification and transformation, the output torque of the actuator acting on the load is lower than the one generated. Different designs of rotational VCD actuators have been developed.

U.S. Pat. No. 8,358,925 B2 discloses an invention of a rotational comb-drive actuator that is used to translate a lens along the optical axis (z). The original motion of the rotor is an out-of-plane rotation which is transformed (with the assistance of similar actuators surrounding the lens) into a vertical deflection of the lens using a complex transformation mechanism. A significant amount of the rotor torque is dissipated during the transformation of the motion. Due to the complexity of the structure of the rotor of this actuator, an undesirable tilt occurs during the translation of the lens when it is actuated by a number of similar actuators. This tilt needs a motion controller to be eliminated.

U.S. Pat. No. 8,269,395 B2 discloses a large stroke rotational comb-drive actuator. It works on the repulsive force principle, and the rotor of the actuator achieves an 86 μm vertical deflection at 200 V based on a rotational stroke at each of the four edges of the actuator which is then amplified using a cantilever beam; however, it provides a low output torque due to the use of an amplification mechanism and to the small area of the fingers used to generate the force.

In translational VCDs, the original motion of the rotor is a translation, and the total electrostatic force that is developed between the electrodes is directly applied to the load attached to the rotor without the use of any stroke amplification or transformation mechanisms. A number of translational VCD actuators were developed. A translational VCD actuator, developed by V. Milanovic et al., achieved a translation stroke of 15 μm at 140 V. The actuator is fabricated using a Direct Reactive Ion Etching (DRIE) of an SOI wafer which enables the fabrication of large height electrodes; however, it provides a low output force as the comb electrode configuration is not area-efficient in terms of overall electrode capacitance. That is because the rotor of the actuator consists of two arrays of fingers (each array is formed along one side of the rotor). The number of fingers in these two arrays can be increased only along one direction, i.e. the lateral direction of comb fingers. U.S. Pat. No. 6,384,952 B1 discloses a translational vertical comb-drive actuator used to actuate a deformable mirror. The actuator has a cavity-tooth configuration which enables achieving a wide area for the electrodes, and it provides an out-of-plane translation of 20 μm at 100 V. However, such an actuator has a number of limitations. First, the teeth and cavities collide when excessive electrostatic attractive forces occur between them (the top surfaces of the teeth collide with the bottom faces of the cavities). Such limitation is well described in US patent application No US2014/0125950 A1. Second, the cavity-tooth configuration leads to gas damping effect between the comb electrodes as gas is trapped between the teeth and the corresponding cavity during motion. This trapped gas has only one outlet (exit) during actuation which is the gap between the moving and fixed fingers. This gap is usually very small in size as compared to the finger width. Third the tooth-cavity configuration requires the rotor and the stator of the actuator to be fabricated separately. The fabricated rotor and stator wafers are then bonded together which may lead to a misalignment of sub-microns size between the upper and lower electrodes. This misalignment limits the stroke of the actuator.

U.S. Pat. No. 7,538,471 B2 discloses a vertical comb-drive actuator configuration that provides an increased rigidity to the optical surface. The goal of the invention is to overcome the problem of optical surface deformation that ensues from the deposition of a reflective metal such as gold or aluminum on the optical surface to enhance its reflectivity. The invention eliminates this problem by reinforcing the comb electrodes beneath the reflected surface in more than one direction. The actuator provides 3-Degrees of Freedom motion, i.e. translation along the z-axis and bi-axial rotation about the in-plane axes (x and y), without the use of any stroke amplification mechanism. It also provides a considerable large output force due to the ability of the electrode configuration to be expanded in more than one dimension. The actuator is fabricated using a surface micromachining process in which the height of the comb electrodes is limited due to the nature of the layer deposition process. These layers cannot be of a large height (thickness), which leads to a limitation on the out-of-plane translation of the actuator. In addition, the comb electrodes have a tooth-cavity configuration that contributes to appreciable damping effects, similar to the issue listed in conjunction with U.S. Pat. No. 6,384,952 B1.

U.S. Pat. No. 8,711,495 discloses a MEMS autofocus mechanism that utilizes three or more translation vertical comb-drive actuators to achieve autofocus in phone cameras. The goal of this invention is to increase the resistance of MEMS Autofocus structure to shocks that occur during the drop test of the mobile phone. The drawbacks of this actuation mechanism include inefficient area-electrode layout, as it utilizes single array comb-drive actuators distributed around the lens, meaning a higher driving voltage is required; limited out-of-plane translational stroke, as the maximum height (thickness) of the electrodes is 20 microns; and low resonant frequency, as the supporting beams have to buckle during the loading of the lens to the central ring to provide an offset between the comb fingers.

In summary, the prior art translational (piston-style motion) VCD actuators have limited performance as they are unable to achieve simultaneously a large output force and a large stroke due to one or more of the following reasons:

(1) Inefficient electrode configurations of the conventional VCD actuators in which the comb fingers have an array-style structure. This structure allows multiplying the number of the fingers only in one dimension along the lateral axis of the fingers; therefore, it leads to generating a low output force. In other words, the comb fingers are essentially free-end cantilevers; hence they cannot be largely elongated along the longitudinal axis to increase the output force. Therefore, the output force can be increased by multiplying the comb fingers only along the lateral axis of the comb fingers.

(2) Bonding misalignments between the rotor and stator electrodes might arise if a translational VCD actuator with a cavity-tooth configuration is fabricated using a bulk micromachining fabrication process.

(3) Significant damping effects in the cavity-tooth configuration of the comb electrodes used in a number of designs that limit the bandwidth of the actuator.

(4) Surface micromachined VCD actuators are limited in terms of being able to provide a large translational (piston-style) stroke. This limitation is due to the inability of surface micromachining processes for depositing large height (thickness) layers.

### SUMMARY OF THE INVENTION

In order to overcome the previously listed problems associated with VCD actuators, a novel electrostatic actuator that utilizes a piston-tube type configuration is developed. The actuator consists of two structures: a fixed one and a moving one. The fixed structure contains a plurality of electrodes which act as pistons in a piston-tube type system. The pistons or teeth may be arranged in square, circular, or any other configuration. These pistons are attached to a base (i.e. the base surfaces on which the piston are positioned define the xy plane) and protrude in a perpendicular direction to it (i.e. along the z-axis), and they form the stator of the actuator. The moving structure contains a plurality of tubes (through holes) that have cross-sections similar to the cross-sections of the pistons. The moving tubes surround an actuator plate, and they are suspended by three or more supporting springs used to return the actuator plate to its initial position in the absence of an applied voltage. The stator and rotor are electrically isolated from each other.

When a voltage difference is applied across the rotor and the stator, an electrostatic force develops between the adjacent pistons and tubes in the vertical direction. This electrostatic force moves the rotor (the free moving structure) from its static position towards the stator (the fixed structure) in a pure translation (piston-style) motion along the z-axis. When the voltage difference drops, the rotor moves back to its equilibrium position due to the restoring force in the supporting springs.

The advantages of the present invention compared to the prior art are as follows:

(1) The piston-tube configuration enables the use of a wide area for the electrodes. Therefore, a high output force can be generated.

(2) The piston-tube configuration significantly reduces the gas damping effects between the actuator electrodes, which is an inherent issue of the cavity-tooth configuration actuators listed previously. That is because no gas is trapped between the pistons and the tubes when they engage during the motion as the tubes are through holes. Squeeze thin-film damping is still present in one embodiment of this actuator, but it can be eliminated by back etching of the fixed structure (the base) to create a central through hole beneath the actuator plate.

(3) The design enables the fabrication of actuator electrodes with an accurate alignment. That is due to the fact that the rotor tubes are patterned and etched after the bonding of the rotor layer (moving structure) to the etched stator layer (fixed structure) using double sided alignment. This technique leads to an accurate alignment between the adjacent pistons and tubes.

(4) The piston-tube configuration with double stator embodiment (two stators bound to the rotor from its two sides that are parallel to the base) enables bi-directional translation of the rotor along the z-axis so that the stroke of the actuator is doubled.

These advantages can be further described through information presented in the following sections.

### BRIEF DESCRIPTION OF DRAWINGS

Embodiments herein will hereinafter be described in conjunction with the appended drawings provided to illustrate and not to limit the scope of the claims, wherein like designations denote like elements, and in which:

FIG. 1A illustrates the fixed structure (pistons) of Embodiment 1 of the piston-tube electrostatic actuator.

FIG. 1B illustrates the moving structure (tubes) of Embodiment 1 of the piston-tube electrostatic actuator.

FIG. 1C is a perspective view illustrating the final structure of Embodiment 1 of the piston-tube electrostatic actuator.

FIG. 1D illustrates a top, detailed view, and a cross-section view of the final structure of Embodiment 1 of the piston-tube electrostatic actuator.

FIG. 2A is a perspective view illustrating the fixed structure (pistons) of Embodiment 2 of the piston-tube electrostatic actuator.

FIG. 2B is a perspective view illustrating the moving structure (tubes) of Embodiment 2 of the piston-tube electrostatic actuator.

FIG. 2C is a perspective view illustrating the final structure of Embodiment 2 of the piston-tube electrostatic actuator.

FIG. 2D illustrates a top, detailed view of the final structure of Embodiment 2 of the piston-tube electrostatic actuator (i.e. black structure within the tubes represent the pistons).

FIG. 3A is a perspective view illustrating the fixed structure (pistons) of Embodiment 3 of the piston-tube electrostatic actuator.

FIG. 3B is a perspective view illustrating the moving structure (tubes) of Embodiment 3 of the piston-tube electrostatic actuator.

FIG. 3C is a perspective view illustrating the final structure of Embodiment 3 of the piston-tube electrostatic actuator.

FIG. 3D is a perspective view illustrating the final structure of Embodiment 3 and a magnified image of an aligned piston-tube system prior to actuation.

FIG. 3E is a perspective view illustrating the final structure of Embodiment 3 and a magnified image of an aligned piston-tube system after actuation when the piston has entered the tube.

FIG. 3F is a top and a cross-sectional view of Embodiment 3 showing the location of a lens that is being actuated.

FIG. 4A is an exploded view of Embodiment 4 (double stators version) of the piston-tube electrostatic actuator illustrating the lower fixed base containing pistons, the rotor containing the tubes, and the upper fixed base containing pistons.

FIG. 4B is a perspective view of Embodiment 4 (double stators version) of the piston-tube electrostatic actuator illustrating the final form of the actuator after the bonding of the three structures.

FIG. 4C is a top view illustrating the final structure of Embodiment 4 of the piston-tube electrostatic actuator.

FIG. 4D is a cross-sectional view illustrating the final structure of Embodiment 4 of the piston-tube electrostatic actuator.

### DETAILED DESCRIPTION OF THE INVENTION

A MEMS electrostatic microactuator, comprising of a first base (stator) plate having a top surface and a thickness; a cavity constructed at the center of the top surface of the base plate sized to receive an actuator plate; an array of spaced apart piston (tooth) electrodes constructed in the thickness of said base plate, wherein said array of pistons (teeth) electrodes surrounding said cavity, wherein said cavity being a closed or an open cavity; each said piston (tooth) electrode having a shape, a length, a height, and a thickness; said array of pistons (teeth) being grouped in one or multiple sub-arrays of pistons (teeth) each comprising one or more pistons (teeth), wherein the pistons (teeth) in all the sub-array of pistons (teeth) being electrically connected to each other; and at least one sub-array of pistons (teeth) being electrically addressable, whereby the array of pistons (teeth) forms the stator of said actuator; a second (rotor) plate attached to said base (stator) plate and having a structure sized to fit on said base (stator) plate, said second (rotor) plate having a fixed peripheral structure and a moving central structure, whereby the fixed structure being attached to the base plate and the moving central structure holding the actuator plate; an array of spaced apart apertures or open tubes constructed in the thickness of said second plate; said array of apertures sized and designed to receive and interdigitate with said array of pistons (teeth), each said aperture or open tubes having a length, width and a height; said array of open tubes being grouped into one or multiple sub-arrays of open tubes that each comprises one or more open tubes, wherein all the sub-arrays of open tubes being electrically connected to each other and electrically isolated from the array of pistons; each sub-array of open tubes being supported by one or more supporting beams extended from the fixed peripheral structure of the second plate to hold them aligned with respect to said array of teeth, whereby the array of open tubes forms the rotor of said actuator; and a plurality of spring means extended along the peripheral structure of said second plate to attach the said rotor to said peripheral structure, and to return the rotor to its initial position in the absence of a driving voltage, each said spring having a length, a thickness, and a height, whereby the pistons (teeth) of the stator penetrate into the open tubes of the rotor during the actuation in response to electrostatic forces from a drive voltage applied between said stator and rotor, and an actuation being achieved by charging the array of pistons (teeth, stator) and open tubes (rotor).

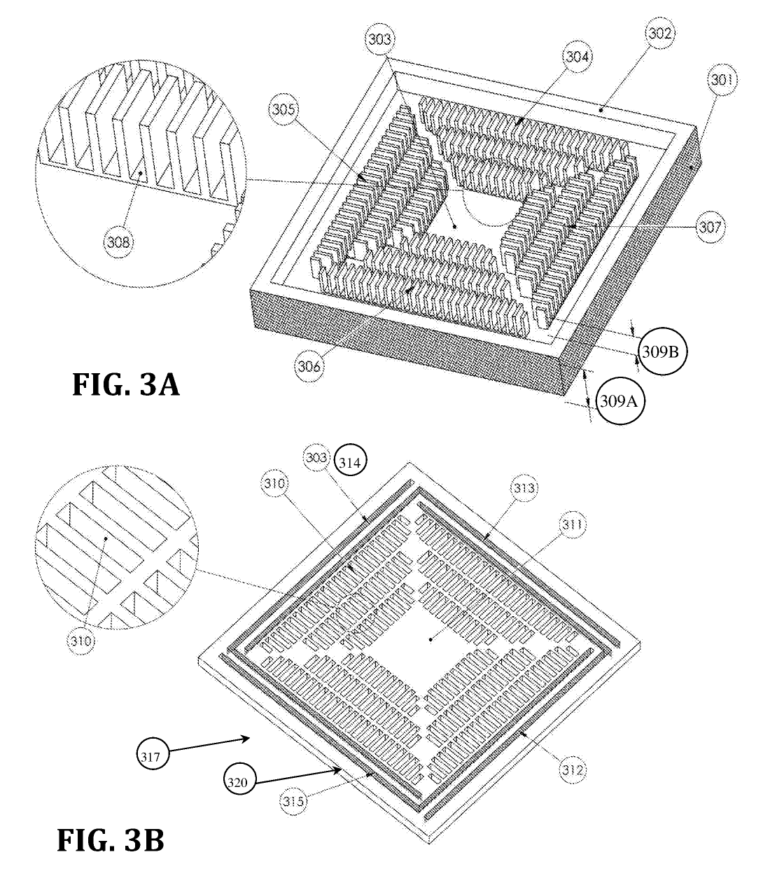

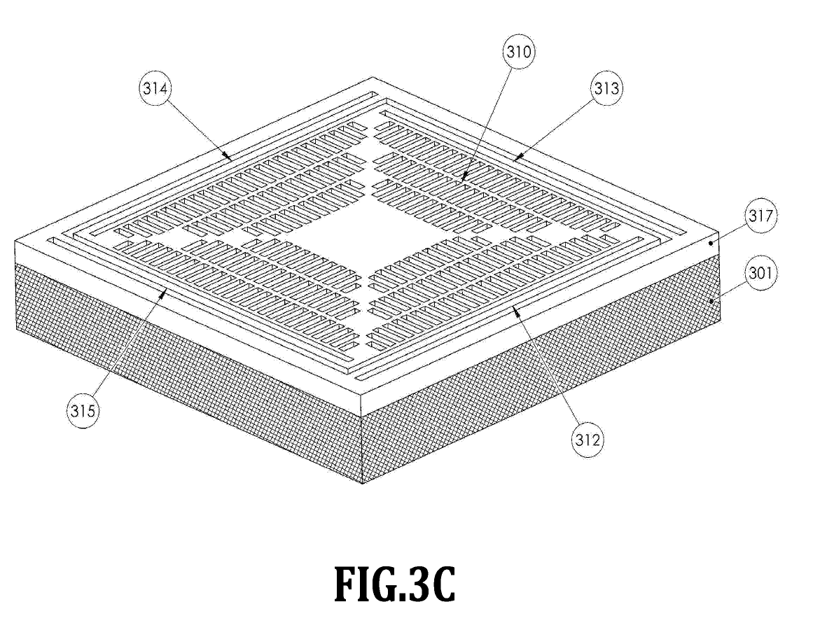

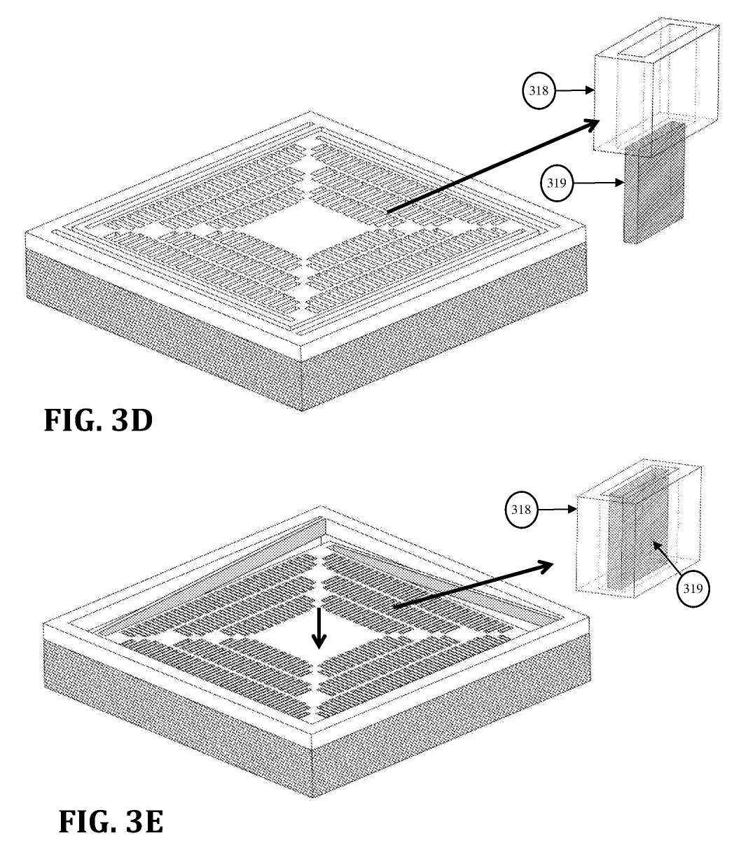

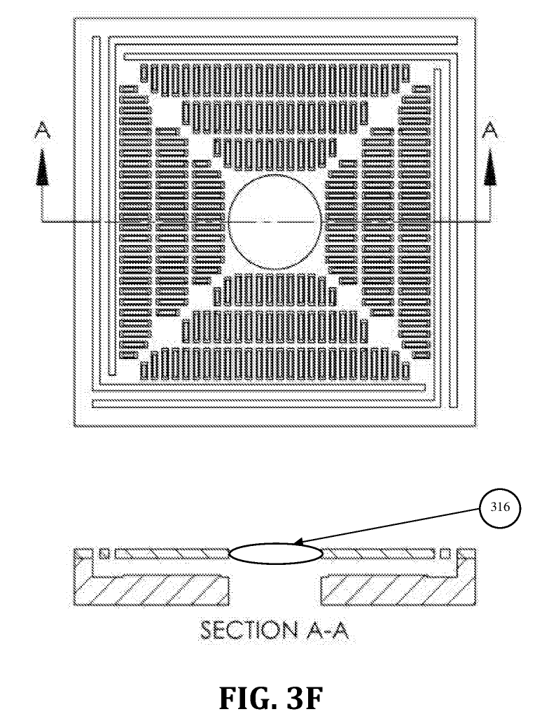

It is apparent to one skilled in the art that the pistons and the corresponding tubes can have many different shapes and designs. For example, the pistons and the tubes can be square, rectangular, circular, or arc-shaped cross-sections (the cross-section plane is parallel to the first plate surface). It is also apparent to one skilled in the art that the springs or the supporting beam configuration can be designed in different arrangement without departing form the spirit of the present invention. These configurations may include suspension beams that extend radially inward towards the center of the actuator plate. Other configurations may include springs or supporting beams that extend along the outer periphery of the moving structure and hold it, or be attached to the fixed periphery of the upper structure (rotor plate), similar to the beam configuration shown in FIG. 3A-C.

### Embodiment 1

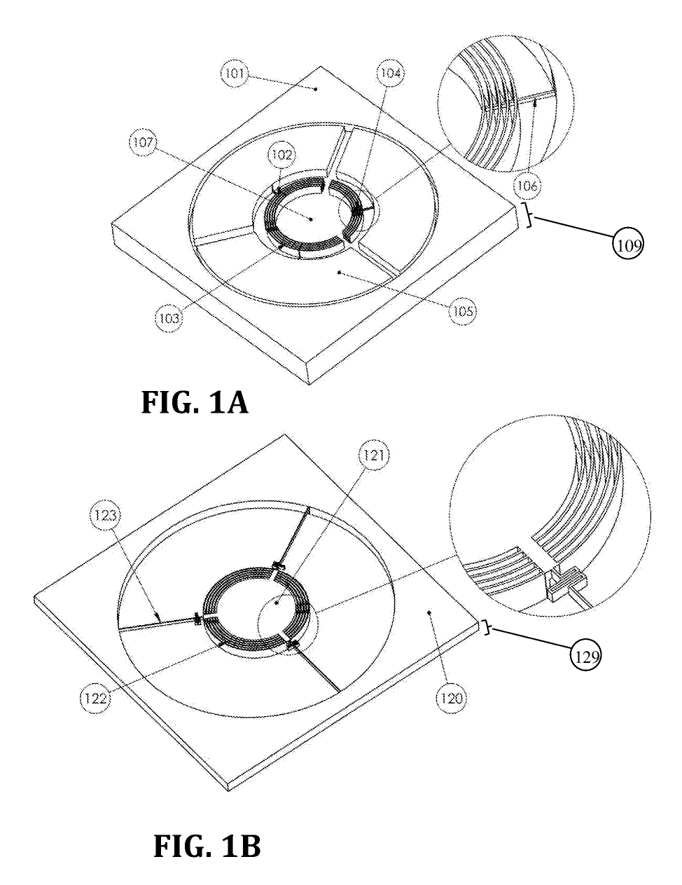

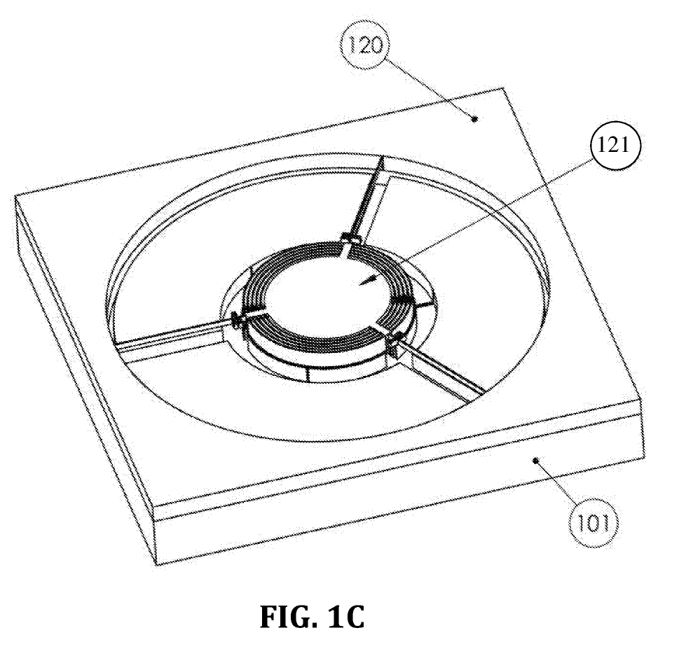

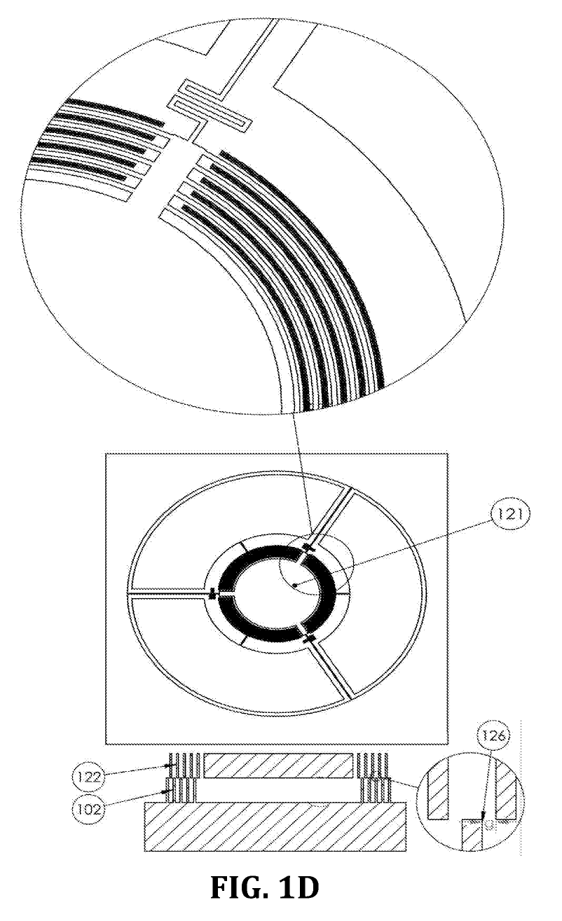

A first embodiment of the present invention (MEMS electrostatic actuator) is illustrated in FIG. 1. The actuator comprises of a fixed structure (stator plate), as illustrated in FIG. 1A, that comprises of a plurality of co-centric arc-shaped teeth (pistons) 102, 103, 104, fabricated in the thickness 109 of a Si wafer 101. The actuator further comprises of a moving structure (rotor plate) that comprises of a plurality of co-centric arc-shaped slots or open tubes 122 (FIG. 1B). The tubes are sized and designed to receive the pistons (teeth) of the fixed structure.

The arc shaped pistons are divided into three groups 102, 103, 104 that are arranged at 120°. The pistons are vertically aligned with the arc-shaped open tubes (slots) 122 in the rotor. The pistons and tubes are electrically isolated from each other which can be achieved by using an insulation layer beneath the pistons (e.g. by utilizing the Buried Oxide (BOX) layer 107 of an SOI wafer) or an insulation layer deposited at the bonding interface between the fixed structure (stator plate) and structure housing the rotor (rotor plate). During the actuation, the pistons enter into the tubes and they inter-digitate during the actuation. The three stator electrode groupings 102, 103, 104 are electrically connected to each other such as via a small thickness (height) layer 106 above the BOX layer. The fixed electrode 101 further comprises of three electrical pads 105 that surround the pistons.

The rotor or the moving electrode is fabricated in the device layer of another Si wafer having a thickness 129, and it comprises a plurality of arc-shaped tubes 122 that surround the actuator plate 121, as illustrated in FIG. 1B. The tubes are attached to the substrate by three supporting beams 123. The final bonded structure of the actuator is shown in FIG. 1C, in which the rotor 120 is set on the top of the stator 101. FIG. 1D shows the top view of the actuator, and the detailed view, which shows how the pistons (black) and tubes (white) are positioned with respect to each other where the gap 126 between pistons and tubes is explicitly shown.

This embodiment was fabricated using a Direct Reactive Ion Etching (DRIE) bulk micromachining process. The DRIE of bulk silicon, unlike surface micromachining processes, enables the fabrication of large thickness (height) electrodes that, in turn, enables the actuator to provide a large stroke.

### Embodiment 2

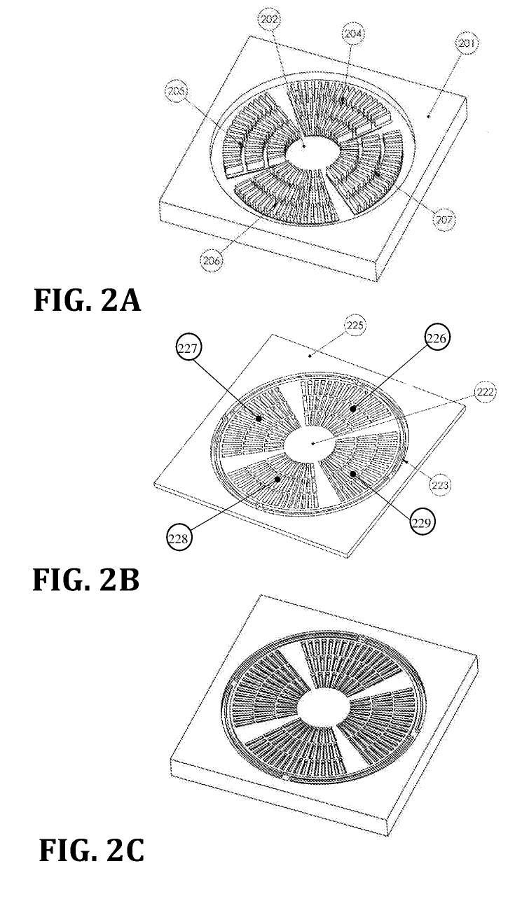

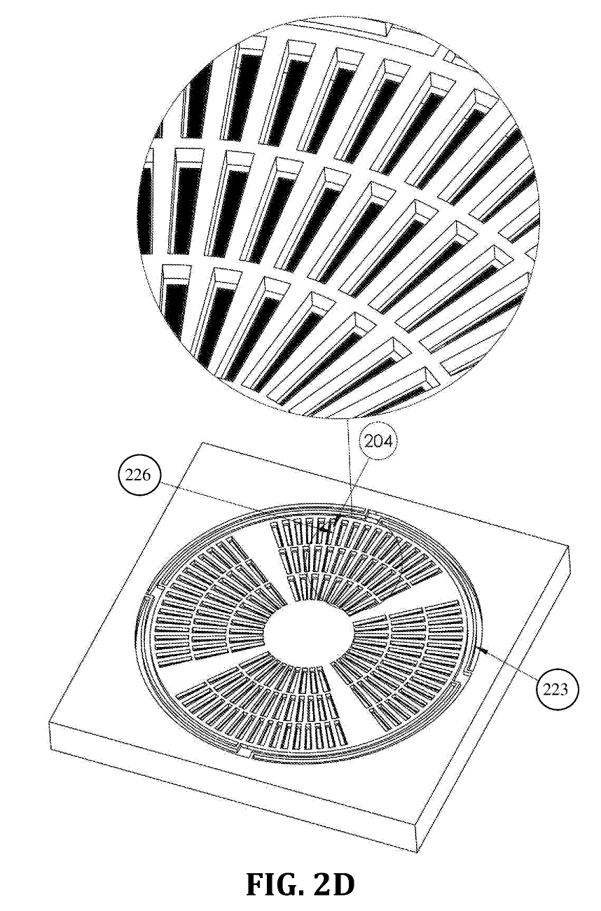

Another embodiment of the present actuator is illustrated in FIG. 2. In this embodiment the pistons and tubes are aligned radially. The electrodes of the stator 201 and the rotor 225 are arranged in such a way that reduces changes in the gap 126 during actuation. The pistons 204, 205, 206, 207 in this embodiment, are fabricated in a Si wafer 201, as plurality of pistons extending vertically upward from the bottom surface of the Si wafer 202, illustrated in FIG. 2A, extend radially from the inside to the outside periphery of the actuator. In this embodiment, the pistons are divided into four groups 204, 205, 206, 207 and they are all electrically connected. Similarly, the open tubes are fabricated in another Si wafer 225, as illustrated in FIG. 2B. The open tubes are also fabricated in four different groups 226, 227, 228, 229, that make the rotor of the actuator. The tubes are fabricated in the thickness of the wafer 225 around an actuator plate 222. The rotor is connected to the outer edges of the wafer by springs or connectors 223. The tubes are all electrically connected to each other but are electrically isolated from the pistons. The combined stator-rotor actuator of this embodiment is illustrated in FIG. 2C. The parallel plate capacitances between the sides of the pistons and tubes extend in the radial direction of the circular plate of the actuator. Although the present embodiment illustrated in FIG. 2D has 4 piston groups, the stator layer can be segmented into any number of sub-arrays). The parallel plate capacitors formed by the pistons and the tubes are normal to the longitudinal direction of the springs, which is the direction of the highest stiffness of the springs 223 (the longitudinal direction of the springs lies on a tangential direction to the actuator plate). Thus, a large out-of-plane translation stroke could be achieved. Another aspect of this embodiment is the configuration of the springs with respect to the rotor, in which the springs are extending along the peripheral of the rotor (see FIG. 2B versus FIG. 1B). This configuration of the springs has four advantages. First, it allows springs to be largely long (leads to having a high ratio of the longitudinal stiffness to the transverse stiffness as the longitudinal stiffness of the beams is inversely proportional to the length and the transverse stiffness is inversely proportional to the length cube). This high value of the ratio pushes the lateral instability limit further, so a large stroke could be achieved. The second advantage is that it provides a wide room for electrodes to be multiplied as opposed to the spring configuration of embodiment 1, see FIG. 1, in which the springs are extending radially inwards leading to the shrinkage of the area of the rotor. Third, the springs could have the same thickness as the rotor (tubes) layer, meaning the fabrication step needed for etching the rotor layer to soften the spring could be eliminated, which simplifies the fabrication process. Fourth, springs with large height (thickness), similar to the electrodes height, make the MEMS electrostatic actuation more resistant to shock when loaded with a mass such as a lens.

### Embodiment 3

Another embodiment of the actuator is illustrated in FIG. 3. The subarrays of pistons 304, 305, 306, 307 in this embodiment have rectangular cross-sections, and they are etched inside the base plate 301. This plate is fixed and it is therefore the stator of the actuator. A supporting frame 302 is kept around the pistons to later attach the rotor plate to. The base plate has a thickness 309A and the pistons have a length (height) 309B. Pistons extend vertically upward from the bottom of the base plate 303. The piston length 309B is smaller than the thickness of the plate 309A. In this embodiment, the pistons are made in four groups, each group comprising of three rows of pistons, extending horizontally along the two in-plane axes (x and y). In case an insulation layer is used beneath the pistons at the bottom of the base plate 303 to separate electrically pistons from tubes, then the pistons in each stator subarray are electrically connected to each other through a small thickness layer 308. Alternatively, an insulation layer can be used at the bonding interface plane between the supporting frame 302 and the surrounding frame of the rotor plate 320 to isolate electrically the pistons from the tubes and as such the layer 308 is not needed.

The rotor plate is fabricated in another Si wafer 317 having a thickness. The tubes are etched inside the wafer in four groups or subarrays, 310. The tubes are rectangular through holes that are sized to fit the corresponding pistons. Each tube facing a piston so that the pistons penetrate into the tubes during the actuation. A supporting frame 320 on the rotor plate holds the section with the tubes. The tubes are movably attached to the supporting frame by one or more springs, 312, 313, 314, 315. FIG. 3C-3E illustrates a completed actuator, wherein a rotor plate 317 is bonded on the top of the stator plate 301 such that all of the tube electrodes are aligned right on the top of the piston electrodes through springs. Therefore, during actuation pistons 319 penetrate into the tubes 318.

The tubes 310 in the rotor are rectangular through holes, and they are facing the pistons so that the pistons penetrate along the tubes during the actuation. This design is more area-efficient in terms of the overall electrodes capacitance than Embodiment 2 in which the corners of the actuator are not utilized due to the geometry of the circular rotor. It also utilizes an efficient spring configuration similar to the one used in embodiment 2.

It is clear that any number of stator subarrays can be fabricated in this configuration. In another embodiment, the rotor could be supported by two or more springs. The actuator plate and the base plate may have a through hole such that an optical element 316 (lens) is attached to the through hole of the actuator plate and allows the penetration of light. The rotor could actuate the lens (or lenses) (i.e. translation along z direction)) to achieve autofocus or zooming feature by selectively translating a lens (or a group of lenses) with an optical train.

### Embodiment 4

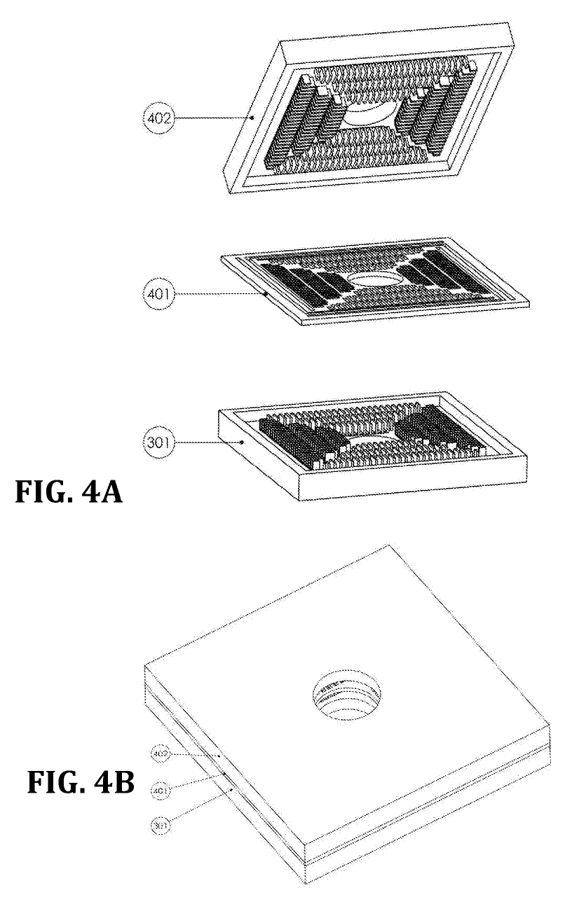

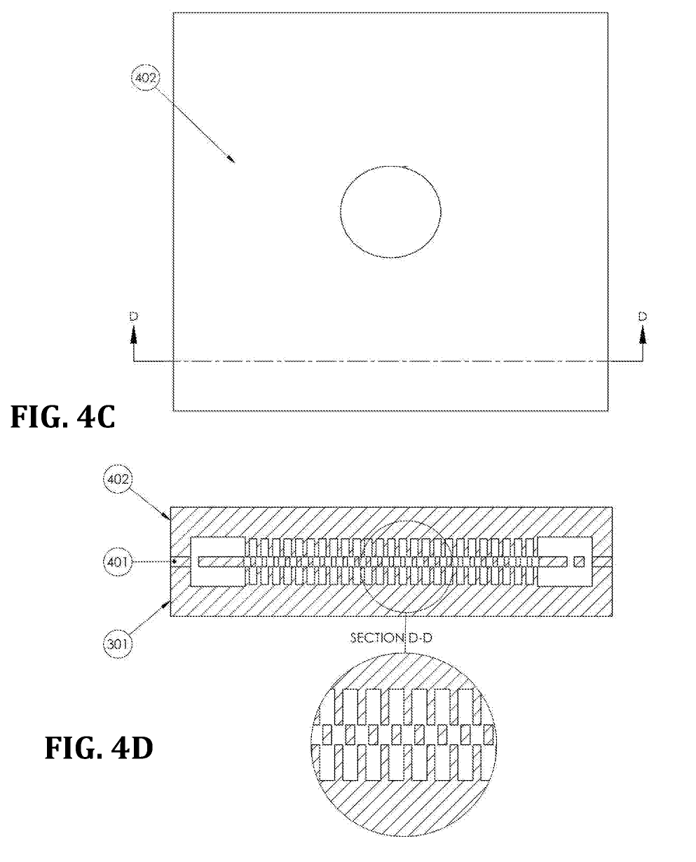

The goal of this embodiment, illustrated in FIG. 4, is to double the translation stroke of the actuator described in Embodiment 3. A base 402 with a central open hole and which has the same features as the lower base 301 of the actuator in Embodiment 3 is bonded to the top surface of the rotor 401. The bonding of this base 402 enables the actuator rotor 401 to translate along the z-axis. Therefore, the stroke of the actuator is doubled as the actuator provides a bi-directional translation. However, bonding misalignments are expected between the upper base 402 pistons and the rotor 401 tubes because the bonding is done after etching the features of both structures (upper base and the rotor). The rotor 401 is attached after bonding to the lower based 301 using backside alignment.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A micro electromechanical system (MEMS) electrostatic actuator, comprising:
a. a first stator plate having an x- and y-axis defining an x-y plane, and a z-direction being perpendicular to the x-y plane, said stator plate having a top surface parallel to the x-y plane, and a thickness along the z-direction, a stator-support-frame surrounding the stator plate; an array of spaced apart piston electrodes extending from the top surface along said z-direction of the stator plate, said pistons having vertical piston-walls and a piston-height; said pistons being electrically connected to each other and electrically addressable;
b. a rotor plate having a non-moving rotor-support-frame surrounding the rotor plate, wherein said rotor-support-frame is placed on and attached to said stator-support-frame;
c. an array of spaced apart tubes being open on both ends fabricated in the rotor plate, each said tube having a vertical tube-wall and a tube-height, wherein said tubes being aligned with said pistons, and wherein each said tube having a tube opening sized and shaped to receive and interdigitate with each said piston without the piston-walls touching the tube-walls, said tubes being electrically connected to each other but electrically isolated from the pistons;
d. a plurality of springs connecting said array of tubes to said non-moving rotor-support-frame, wherein during an actuation in response to electrostatic forces from a drive voltage applied between said arrays of pistons and said rotor plate, the rotor translates along the z-direction, and
e. an actuator-plate attached to said rotor plate and surrounded by said tubes, wherein said actuator plate forms a single rigid body with said tubes,
whereby said actuator provides a one dimensional translational motion along the z-direction.

2. The MEMS electrostatic actuator of claim 1, wherein the cross-section along the plane defined by the x and y axes of each said piston and each said tube being substantially rectangular, circular, triangular, trapezoidal, pentagonal, or hexagonal shaped, and each said tube being sized to let each said piston to enter the tube opening without touching said tube-walls.

3. The MEMS electrostatic actuator of claim 1, wherein said array of pistons and said array of tubes comprising of multiple linear rows of pistons and tubes aligned along the x-axis and y-axis.

4. The MEMS electrostatic actuator of claim 1, wherein said array of pistons and said array of tubes comprising of multiple concentric circular rows of pistons and tubes, wherein said pistons and tubes are aligned both radially and circumferentially.

5. The MEMS electrostatic actuator of claim 1, wherein said array of pistons and said array of tubes arranged in multiple sectors, wherein said pistons and tubes are aligned both radially and circumferentially in each said sector.

6. The MEMS electrostatic actuator of claim 1, further having an object placed on the rotor, whereby said object can move along the z-direction.

7. The MEMS electrostatic actuator of claim 1, wherein said rotor plate having a rotor-opening, and said stator plate having a stator-cavity, whereby an object can be placed in the rotor-opening and be vertically translated into the stator-cavity.

8. The MEMS electrostatic actuator of claim 7, wherein said stator-cavity being an open cavity to allow light to penetrate through the actuator, and wherein said object being an optical lens or a plurality of lenses.

9. The MEMS electrostatic actuator of claim 7, wherein said stator cavity being an open cavity to allow light to penetrate through the actuator, and wherein said actuator integrated in a miniature camera, whereby the actuator is used for autofocus, zooming and optical image stabilization in said camera.

10. The MEMS electrostatic actuator of claim 1, wherein said plurality of springs being aligned longitudinally along said rotor-support-frame.

11. The MEMS electrostatic actuator of claim 1, wherein said MEMS actuator stator is fabricated in a SOI wafer using a Direct Reactive Ion Etching (DRIE) bulk micromachining process.

12. The MEMS electrostatic actuator of claim 1, wherein stator pistons and rotor tubes being electrically isolated from one another by utilizing the Buried Oxide (BOX) layer of the SOI wafer and being electrically connected.

13. The MEMS electrostatic actuator of claim 1, wherein stator pistons and rotor tubes being electrically isolated from one another by utilizing an insulation layer at the bonding interface between the stator-support-frame and the non-moving rotor-support-frame.

14. The MEMS electrostatic actuator of claim 1, further having:
a. a second stator plate, wherein said rotor plate being sandwiched between the first stator plate and the second stator base plate; and
b. said second stator plate being mirror image of said first stator plate, having a thickness, a central cavity, an array of spaced apart piston electrodes constructed in the thickness of said second stator plate, wherein said array of teeth electrodes surrounding said cavity, each said piston electrode having a shape, a length, a height, and a thickness, wherein the pistons are electrically connected to each other and are electrically addressable, whereby through a reciprocating motion of the rotor, the pistons of the first and second stator plates penetrate into the openings of the rotor during the actuation in response to electrostatic forces from a drive voltage applied between said stators and rotor, and an actuation is achieved by charging said arrays of pistons and tubes.
